(19) United States
(12) Patent Application Publication
(10) Pub. No.: US 2025/0257857 A1
(43) Pub. Date: Aug. 14, 2025

(54) DIGITAL MICROMIRROR DEVICE IN HIGH RESOLUTION LAMP

(71) Applicant: Rivian IP Holdings, LLC, Irvine, CA (US)

(72) Inventors: Simon Baker, Basingstoke (GB); Shammika Ashan Wickramasinghe, Banbury (GB); Timothy Beaven, Bicester (GB); Carlos Montes Relanzon, Trabuco Canyon, CA (US)

(73) Assignee: Rivian IP Holdings, LLC, Irvine, CA (US)

(21) Appl. No.: 18/753,339

(22) Filed: Jun. 25, 2024

Related U.S. Application Data
(60) Provisional application No. 63/553,336, filed on Feb. 14, 2024.

(51) Int. Cl. F21S 41/675

(52) U.S. Cl. CPC F21S 41/675

(57) ABSTRACT

Systems and method described herein are directed a digital micromirror device high resolution lamp system. The system can include an optical module. The optical module can be configured to dispose inside a headlamp. The optical module can include an array of micromirrors. The system can include one or more processors coupled with memory. The one or more processors can be configured to provide a beam of light. The beam of light can include an origin. The one or more processors can be configured to control a zone within the beam of light, using the array of micromirrors. The zone can be configured to project a graphic within the beam of light. The zone can include at least a 400:1 contrast ratio within at least a 20 degree by 10-degree field of view from the origin.

### CROSS REFERENCE TO RELATED PATENT APPLICATION

The present application claims the benefit of and priority to U.S. Provisional Patent Application No. 63/553,336, filed Feb. 14, 2024, the disclosure of which is incorporated herein by reference in its entirety.

### INTRODUCTION

Electric vehicles (EVs) can be powered using batteries that store energy to reduce greenhouse gas emissions. The batteries can include different components facilitating energy storage and distribution.

### SUMMARY

At least one aspect can be directed to a digital micromirror device high resolution lamp system. The system can include an optical module. The optical module can be configured to dispose inside a lamp such as a headlamp, rear lamp, a signal lamp, fog lamp or other lamp. The optical module can include an array of micromirrors. The system can include one or more processors coupled with memory. The one or more processors can be configured to provide a beam of light. The beam of light can include an origin. The one or more processors can be configured to control a zone within the beam of light, using the array of micromirrors. The zone can be configured to project a graphic within the beam of light. The zone can include, for example, at least a 400:1 contrast ratio within at least a 20 degree by 10-degree field of view from the origin.

At least one aspect can be directed to a method. The method can include providing a beam of a light. The beam of light can include an origin. The method can include controlling a zone within the beam of light to project a graphic within the beam of light, using an array of micromirrors disposed within an optical module. The zone can include at least a 400:1 contrast ratio within at least a 20 degree by 10-degree field of view from the origin.

At least one aspect can be directed to an electric vehicle. The electric vehicle include a digital micromirror device high resolution lamp system. The system can include an optical module. The optical module can be configured to dispose inside a headlamp. The optical module can include an array of micromirrors. The system can include one or more processors coupled with memory. The one or more processors can be configured to provide a beam of light. The beam of light can include an origin. The one or more processors can be configured to control a zone within the beam of light, using the array of micromirrors. The zone can be configured to project a graphic within the beam of light. The zone can include at least a 400:1 contrast ratio within at least a 20 degree by 10-degree field of view from the origin.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1A depicts an example of a system for a digital micromirror device (DMD) high resolution lamp;

FIG. 1B depicts an example of an array of micromirrors for the DMD high resolution lamp;

FIG. 1C depicts another example of the array of micromirrors for the DMD high resolution lamp;

FIG. 2A depicts an example cross-sectional view of an electric vehicle;

FIG. 2B depicts an example of the DMD high resolution lamp;

FIG. 2C depicts another example of the DMD high resolution lamp;

FIG. 3 depicts an example of a high-definition area of the electric vehicle;

FIG. 4 is a flow diagram illustrating an example method of executing the DMD high resolution lamp; and

FIG. 5 depicts an example of a computer system within the electric vehicle.

### DETAILED DESCRIPTION

Following below are more detailed descriptions of various concepts related to, and implementations of, methods, apparatuses, and systems of integrating a digital micromirror device into a high-resolution lamp of an electric vehicle. The various concepts introduced above and discussed in greater detail below may be implemented in any of numerous ways.

This disclosure is generally directed to a digital micromirror device (DMD) high resolution lamp. Vehicles configured to produce a high-resolution light beam from a headlamp can be limited in a size or ratio of the high-definition light beam due to insufficient quantities of micromirrors and challenges associated with adding additional micromirrors. Adding additional micromirrors to a headlamp configuration can face technical and other challenges associated with size constraints of a headlamp enclosure and excessive heat output by the micromirrors. The headlamp enclosure can define a form factor for an array of micromirrors which is difficult to achieve with large amounts of micromirrors. Furthermore, excessive heat generated by controlling large amounts of micromirrors can harm the operation of the micromirror array by causing dielectrics of the micromirrors to become sticky, preventing the micromirrors from flipping states.

This technical solution provides a system that can emit a light beam including a high-definition area greater than a threshold size or resolution from a headlamp of a vehicle. The system can project images through the high-definition area to display on a surface. To perform these functionalities, the system can control subsets of an array including 1.2-1.5 million micromirrors. The array can include different examples of micromirrors, for example greater than 1.5 million micromirrors. By controlling the subsets of the array as pixels, the system can enable a projection of a high-definition area within a light beam from a headlamp of a vehicle in a greater ratio or size than conventional systems. The system can include advanced optical components designed to sustain the area of micromirrors, such as a particular lens, light absorber, and light-emitting diode to enable the projection of the high-definition area within the light beam.

Thus, this technical solution can provide a high-definition light beam above a certain size without compromising resolution, generating excessive heat, or wasting power. Furthermore, the high-definition light beam can be configured to project from a headlamp of a vehicle, thereby conforming to a smaller form factor which can further reduce wasted resources.

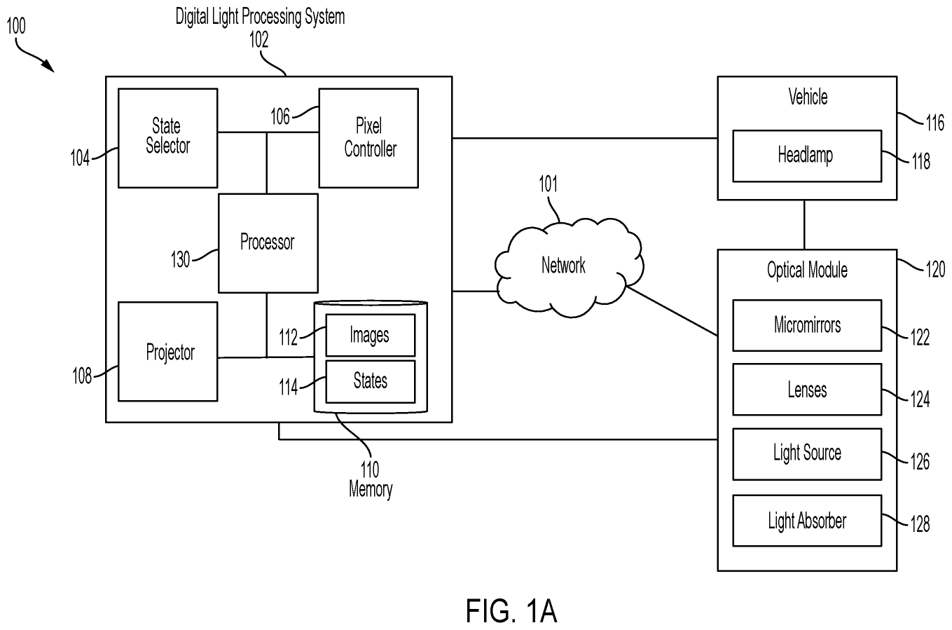

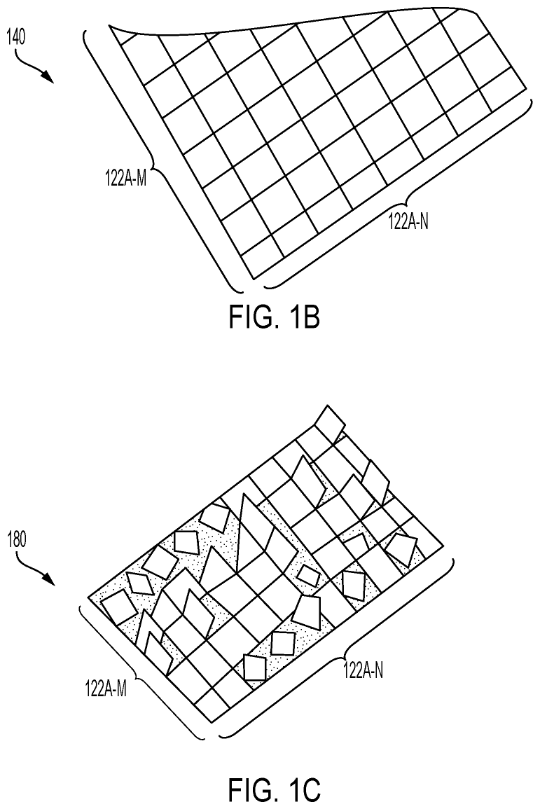

FIG. 1 depicts an example of a system 100 for a digital micromirror device (DMD) high resolution lamp. The system 100 can include a data processing system 102, a vehicle 116 (sometimes referred to as “electric vehicle 116” herein), and an optical module 120. The above-mentioned components may be connected to each other through a network 101. The examples of the network 101 may include, but are not limited to, private or public LAN, WLAN, MAN, WAN, and the Internet. The network 101 may include both wired and wireless communications according to one or more standards and/or via one or more transport mediums.

The communication over the network 101 may be performed in accordance with various communication protocols such as Transmission Control Protocol and Internet Protocol (TCP/IP), User Datagram Protocol (UDP), and IEEE communication protocols. In one example, the network 101 may include wireless communications according to Bluetooth specification sets, or another standard or proprietary wireless communication protocol. In another example, the network 101 may also include communications over a cellular network, including, e.g., a GSM (Global System for Mobile Communications), CDMA (Code Division Multiple Access), EDGE (Enhanced Data for Global Evolution) network.

The system 100 is not confined to the components described herein and may include additional or alternate components, not shown for brevity, which are to be considered within the scope of the embodiments described herein.

The system 100 can include at least one optical module 120. The optical module 120 can be disposed in a headlamp 118. The headlamp 118 may illuminate a road ahead of a driver of the vehicle 116. The headlamp 118 can be located at the front of the vehicle 116. For example, a headlamp 118 can be located at the front of a vehicle 116. The headlamp 118 can include at least a low beam and a high beam setting. For example, a headlamp 118 with a low beam setting may illuminate a road in front of a vehicle 116, whereas a high beam setting can produce a brighter illumination of the road in front of the vehicle 116. The headlamp 118 can automatically turn on while the vehicle 116 is in motion during the day. For example, a headlamp 118 can automatically turn on while a vehicle 116 is in motion.

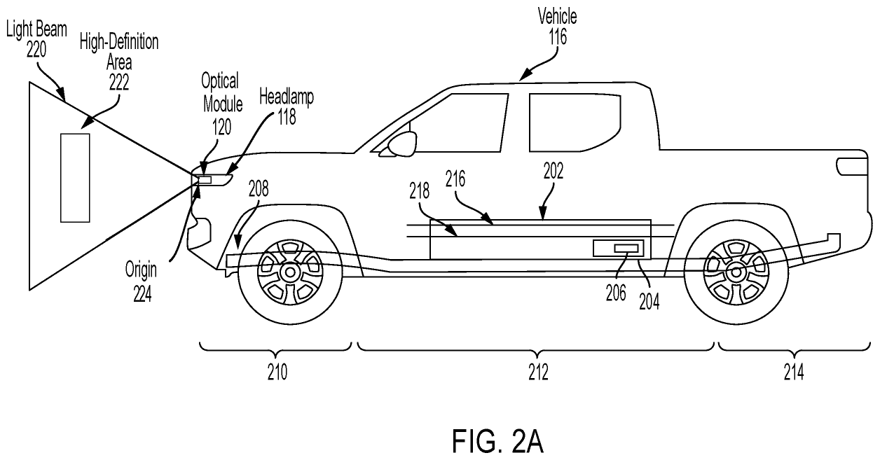

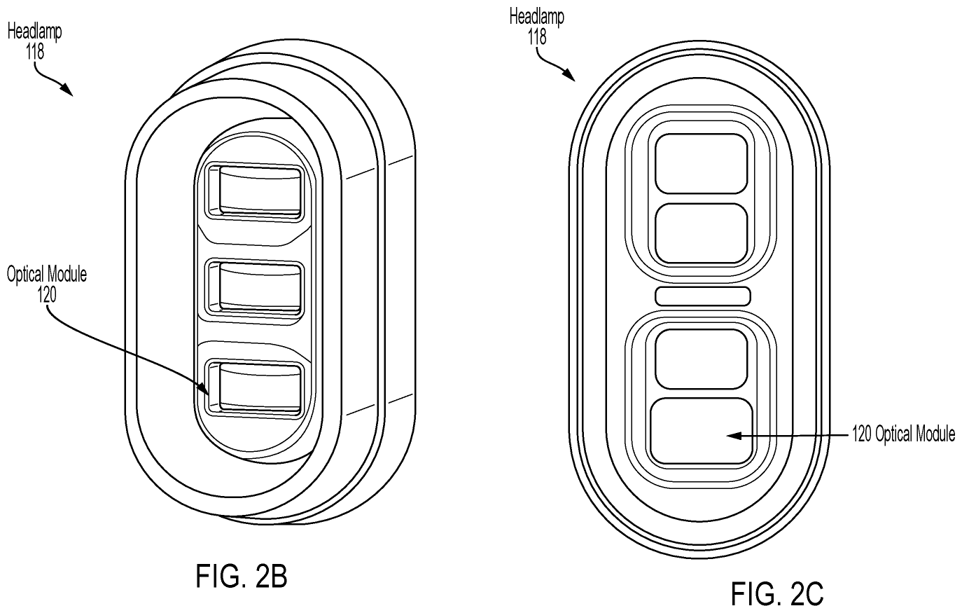

Referring to FIG. 1 and FIG. 2A. FIG. 2A depicts an example cross-sectional view 200 of an electric vehicle 116 installed with at least one battery pack 202. Electric vehicles 116 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 202 can also be used as an energy storage system to power a building, such as a residential home or commercial building. Electric vehicles 116 can be fully electric or partially electric (e.g., plug-in hybrid) and further, electric vehicles 116 can be fully autonomous, partially autonomous, or unmanned.

Electric vehicles 116 can also be human operated or non-autonomous. Electric vehicles 116 such as electric trucks or automobiles can include on-board battery packs 202, battery modules 204, or battery cells 206 to power the electric vehicles 116. The electric vehicle 116 can include a chassis 208 (e.g., a frame, internal frame, or support structure). The chassis 208 can support various components of the electric vehicle 116. The chassis 208 can span a front portion 210 (e.g., a hood or bonnet portion), a body portion 212, and a rear portion 214 (e.g., a trunk, payload, or boot portion) of the electric vehicle 116. The battery pack 202 can be installed or placed within the electric vehicle 116. For example, the battery pack 202 can be installed on the chassis 208 of the electric vehicle 116 within one or more of the front portions 210, the body portion 212, or the rear portion 214.

The battery pack 202 can include or connect with at least one busbar, e.g., a current collector element. The first busbar 216 and the second busbar 218 can include electrically conductive material to connect or otherwise electrically couple the battery modules 204 or the battery cells 206 with other electrical components of the electric vehicle 116 to provide electrical power to various systems or components of the electric vehicle 116. The battery pack 202 can provide power to the any components described in system 100. For example, the battery cells 206 or the battery modules 218 can connect with other electrical components of the electric vehicle 116 to provide electrical power to various systems or components of the electric vehicle 116.

Referring to FIG. 1 and FIGS. 2B-2C, FIGS. 2B-2C depict examples of the DMD high resolution lamp such as headlamp 118. The headlamp 118 can include four optical modules 120 as shown in FIG. 2B. For example, a headlamp 118 of an electric vehicle 116 can include four optical modules 120 disposed within the headlamp 118. The headlamp 118 can include three optical modules 120 as shown in FIG. 2C, as well as other numbers of optical modules 120. For example, a headlamp 118 of an electric vehicle 116 can include three optical modules 120 disposed within the headlamp 118. The three optical module headlamp 118 can create a more powerful beam of light in comparison to the four optical module headlamp. Each optical module 120 in the four optical module headlamp 118 can include a greater number of micromirrors in comparison to the three optical module headlamp. The headlamp 118 can be placed at the rear of the electric vehicle 116. For example, a rear headlamp 118 with three optical modules 120 can be placed at the rear of an electric vehicle 116. The digital micromirror device described herein can integrate into or be disposed within the headlamp 118. For example, an array of micromirrors 122 can be located within the optical module 120 or within one or more cavities of the headlamp 118 in a symmetrical, asymmetrical, two dimensional, or three-dimensional arrangement to allow for directional or intensity control of emitted light out from the headlamp 118.

The headlamp 118 can include a stadium shape as shown in FIGS. 2B-2C. The stadium shape can include two parallel lines and two semicircles as shown in FIGS. 2B-2C. The stadium shape can be a curved or elliptical like design. The stadium shape of the headlamp 118 can include a depth resembling a bowl. The stadium shape can include angular contours and sharp edges to form the bowl. One or more optical modules 120 can be disposed along a vertical axis within the headlamp 118. The processor 130 can direct electrical energy to illuminate the headlamp 118 to provide the light beam 220. The processor 130 can use the optical module 120 to provide the light beam 220. For example, the processor 130 can control the optical module 120 to adjust the array of micromirrors 122 to provide the light beam 220.

The system 100 can include at least one array of micromirrors 122 located within the optical module 120. The array of micromirrors 122 can be a plurality of micromirrors 122 arranged in a structured pattern and each micromirror 122 in the plurality of micromirrors 122 may have a dimensionality in micrometers. For example, a plurality of micromirrors 122 may include 1.2 million to 1.6 million micromirrors 122. The array of micromirrors 122 can be disposed along the optical module 120. For example, an array of micromirrors 122 can be arranged within the optical module 120. The optical module 120 can include at least one lens 124, light source 126, and light absorber 128.

Referring now to FIG. 1A and FIG. 1B, FIG. 1B depicts an example 140 of the array of micromirrors 122 for the DMD high resolution lamp. In the optical module 120 of the headlamp 118, the array of micromirrors 122 can include the plurality of micromirrors (e.g., micromirrors 122A-M, micromirrors 122A-N). Electronic circuits, one or more processors (e.g., processor 130, pixel controller 106) can control each micromirror 122 in the array of micromirrors 122. Each micromirror can include an orientation and a tilt. The orientation defines a degree of rotation for each micromirror 122. The tilt defines a level of elevation (i.e., raise or lower) for each micromirror 122. Each micromirror 122 can rotate between 0 and 90 degrees. In example 140, each micromirror 122 is at 0 degrees. Referring now to FIG. 1C, FIG. 1C depicts another example 180 of the array of micromirrors 122 for the DMD high resolution lamp. Example 180 shows each micromirror 122 with various tilts and orientations. For example, a first set of micromirrors 122 can elevate to a first angle of elevation and a second set of micromirrors can elevate to a second angle of elevation. In another example a first set of micromirrors 122 can rotate to a first degree of rotation and a second set of micromirrors can rotate to a second degree of rotation.

Referring again to FIG. 1, the system 100 can include at least one processor 130 within the data processing system 102. The data processing system 102 can include a physical computer system operatively coupled or that can be coupled with one or more components of the system 100, either directly or through an intermediate computing device or system. The data processing system 102 can include a virtual computing system, an operating system, and a communication bus to effect communication and processing. The data processing system 102 can include at least one processor 130, state selector 104, pixel controller 106, projector 108, and memory 110.

The processor 130 can execute one or more instructions associated with the system 100. The processor 130 can include an electronic processor, an integrated circuit, or the like including one or more of digital logic, analog logic, digital sensors, analog sensors, communication buses, volatile memory, nonvolatile memory, and the like. The processor 130 can include, but is not limited to, at least one microcontroller unit (MCU), microprocessor unit (MPU), central processing unit (CPU), graphics processing unit (GPU), physics processing unit (PPU), embedded controller (EC), or the like. The processor 130 can include a memory operable to store or storing one or more instructions for operating components of the processor 130 and operating components operably coupled to the processor 130. For example, the one or more instructions can include one or more of firmware, software, hardware, operating systems, embedded operating systems. The processor 130 or the system 100 generally can include one or more communication bus controller to effect communication between the processor 130 and the other elements of the system 100.

The system 100 can include at least one memory 110 within the data processing system 102. The memory 110 can be coupled to the processor 130. The memory 110 can store data associated with the system 100. The memory 110 can include one or more hardware memory devices to store binary data, digital data, or the like. The memory 110 can include one or more electrical components, electronic components, programmable electronic components, reprogrammable electronic components, integrated circuits, semiconductor devices, flip flops, arithmetic units, or the like. The memory 110 can include at least one of a non-volatile memory device, a solid-state memory device, a flash memory device, and a NAND memory device. The memory 110 can include one or more addressable memory regions disposed on one or more physical memory arrays. A physical memory array can include a NAND gate array disposed on, for example, at least one of a particular semiconductor device, integrated circuit device, or printed circuit board device. The memory 110 can include images 112 and states 114.

The processor 130 and the memory 110 can provide at least one beam of light. To provide the beam of light (referred to as light beam 220 herein), the processor 130 can communicate, via the network 101, with the optical module 120. For example, a processor 130 can transmit an instruction to an optical module 120 to provide a light beam 220. The optical module 120 can include a light source 126. The light source 126 can be a component of the optical module 120 responsible for generating light. For example, an optical module 120 may trigger a light source 126 to produce a plurality of light rays to generate light. The light source 126 can be at least one of but is not limited to a light emitting diode (LED), a laser diode, an incandescent lamp, a halogen lamp, a white light source, or a phosphor converted LED, among others. For example, a light source 126 can be a LED. In another example, a light source 126 can be a laser diode.

The optical module 120 can include at least one lens 124 to control propagation of the light source 126. The lens 124 may control the propagation of the light source 126 through the concept of refraction. The concepts of refraction can include focusing (e.g., convergence and divergence of the light source 126), collimating (e.g., control the divergence of light, ensure light rays are parallel), and beam shaping (e.g., altering intensity distribution, divergence, or convergence). For example, a lens 124 may be in the shape of a concave (e.g., divergence) to cause parallel light rays from a light source 126 to diverge from a focal point. The optimal module 120 can include a plurality of lenses 124 to achieve a desired performance.

The light beam 220 can include at least one origin 224 within the headlamp 118. The origin 224 of the light beam 220 can be a point, apex, or a focal point at which the light beam 220 begins propagation from the light source 126. For example, an origin 224 of a light beam 220 can be the starting point of the light beam 220. The origin 224 can be located after the optical module 120 to allow the light beam 220 to propagate from the light source 126 located within the optical module 120. The origin 224 can be placed based on the characteristics of the light source 126. For example, for brighter light source 126 may have an origin 224 closer to the front of a vehicle to illuminate a larger area.

The light beam 220 can converge at the origin 224 after emitting from the light source 126. The design of the lens 124 can dictate the position of the origin 224 to maximize illumination efficiency and visibility for the driver, occupant, or operator of the electric vehicle 116. The origin 224 can cause the headlamp 118 to provide an evenly distributed light beam 220 to enhance visibility without cause a glare or blind oncoming drivers. By controlling the placement of the origin 224, the electric vehicle 116 can control light intensity and beam shape of the light beam 220.

The system 100 can include at least one pixel controller 106 within the data processing system 102. The pixel controller 106 can have the same structure and hardware components as the processor 130. The pixel controller 106 can use the array of micromirrors 122 to control a zone (referred to as high-definition area 222 herein) within the light beam 220. To use the array of micromirrors 122, the pixel controller 116 may be configured to control at least one micromirror 122 of the array of micromirrors 122. The pixel controller 106 controlling at least one micromirror 122 in unison can define a pixel. For example, a pixel controller 106 can adjust the pattern of two micromirrors 122 in the array of micromirrors 122. In another example, a pixel controller 106 can adjust the pattern of fifty micromirrors 122 in the array of micromirrors 122.

The pixel can be an element that corresponds to at least one micromirror 122 in the array of micromirrors 122 used in unison. For example, two micromirrors 122 controlled by a pixel controller 106, can define a pixel. In another example, 50,000 micromirrors 122 controlled by a pixel controller 106, can define a plurality of pixels. The pixel controller 106 can be configured to control a plurality of pixels. For example, a pixel controller 106 can control 900,000 pixels. In another example, a pixel controller 106 can control 975,000 pixels. In yet another example, a pixel controller 106 can control 990,980 pixels. In yet another example, a pixel controller 106 can control 1 million pixels.

Controlling the pixels can require the pixel controller 106 to adjust or tilt at least one micromirror 122 in the array of micromirrors 122. The pixel controller 106 can determine an angle at which to tilt each micromirror 122 in the array of micromirrors 122. For example, a pixel controller 106 can tilt at least one micromirror 122 to have an angle 2 degrees. In another example, a pixel controller 106 can tilt a first set of at least one micromirror 122 to 13 degrees and tilt a second set of micromirrors 122 to 15 degrees. To determine the angle, the processor 130 may transmit a signal to the pixel controller 106 in response to the processor 130 detecting an oncoming vehicle 116. The signal may include a distance of the oncoming vehicle, a size of the coming vehicle, and a speed of the oncoming vehicle. Using the distance, the speed, and the size, the pixel controller 116 may calculate the angle to tilt or adjust the micromirrors 122. The pixels can define a resolution for the array of micromirrors 122. For example, a resolution for an array of micromirrors 122 can be 9:5, where there are 9 micromirrors 112 in a horizontal (or first) direction for every 5 micromirrors 112 in a vertical (or second) direction.

The system 100 can include at least one state selector 104 within the data processing system 102. The state selector 104 can have the same structure and hardware components as the processor 130. The state selector 104 can receive instructions or signals from the pixel controller 106 to change a state 114 of one or more micromirrors 122 in the array of micromirrors 122. For example, to control a pixel, a pixel controller 106 can send a first signal to a state sector 104 to tilt one or more micromirrors 122 in an array of micromirrors 122 to change to a first state 114. During a future time period, the pixel controller 106 can send a second signal to the state sector 104 to tilt the one or more micromirrors 122 in the array of micromirrors 122 to change to a second state 114. Tilting the array of micromirrors 122 can be interchangeable with change the state of the array of micromirrors 122.

In response to the state selector 104 receiving an instruction or signal from the pixel controller 106, the state selector 104 can communicate with the memory 110 to select one state 114 from the states 114. Each state 114 within the states 114 in memory 110 can correspond to an angle tilt one or more micromirrors 122 in the array of micromirrors 122. For example, one state 114 can correspond to a two-degree tilt of one or more micromirrors 122. In another example, one state 114 can correspond to a 15-degree tilt of one or more micromirrors 122. In yet another example, one state 114 can correspond to a 30-degree tilt of one or more micromirrors 122. The signal sent by the pixel controller 106 can indicate a number of degrees to tilt one or more micromirrors 122. For example, the signal can indicate that the one or more micromirrors 122 should be tilted to 11 degrees.

The pixel controller 106 or the processor 130 can control the high-definition area 222 within the light beam 220. To control the high-definition area 222, the pixel controller 106 or the processor 130 can use the array of micromirrors 122. The high-definition area 222 can be an have a dimensionality within the light beam 220 where objects, structures, and/or landscapes are emphasized. The dimensionality can include clearer images of the objects, structures, and/or landscapes. For example, an oncoming vehicle 116 within the high-definition area 222 may be clearer to an operator of an incoming vehicle 116.

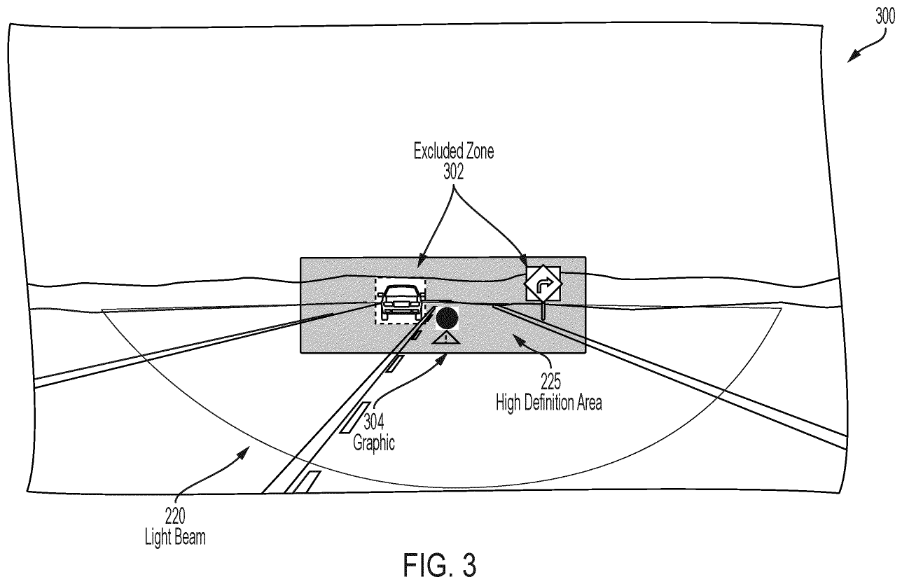

Referring to FIG. 2 and FIG. 3, FIG. 3 depicts an example 300 of a high-definition area 222 of the electric vehicle 116. The high-definition area 222 can include a contrast ratio of at least 400:1 within the light beam 220 as seen in example 300. For example, a high definition area 222 can include a contrast ratio of 400:1. In another example, a high definition area 222 can include a contrast ratio of 500:1. In yet another example, a high definition area 222 can include a contrast ratio of 600:1. The contrast ratio can be within at least a 20 degree by 10 degree field of view from the origin 224 of the light source 126. For example, a contrast ratio can be within a 20 degree by 10-degree field of view from the origin 224. In another example, a contrast ratio can be within a 30 degree by 20-degree field of view from an origin 224 from the light source 126. In yet another example, a contrast ratio can be within a 40 degree by 20-degree field of view from an origin 224 from the light source 126.

The high-definition area 222 can include at least 1000 lumens. For example, a high-definition area 222 can include 1000 lumens. In another example, a high-definition area 222 can include 2000 lumens. In yet another example, a high-definition area 222 can include 5000 lumens. A lumen can be a unit of measurement to establish a total amount of visible light emitted by the light source 126. The lumen can measure the brightness of the light source 126 perceived by a human eye. For example, a light source 126 with 5000 lumens may be brighter than a light source 126 with 1000 lumens. In another example, a light source 126 with 5000 lumens may be similar than a light source 126 with 5000 lumens.

The system 100 can include at least one light absorber 128 with the optical module 120. The light absorber 128 can absorb or attenuate the light beam 200 within a wavelength range. The light absorber 128 can reduce stray light that can interfere with an image 112. For example, a light absorber 128 can include one or more sensors to minimize stray light to improve an image 112. The light absorber 128 can reduce flare that may reflect of objects, vehicles 116, landscapes, and surfaces. For example, a light absorber 128 may absorb reflected light to reduce flare. The light absorber 128 can employ thermal control for the optical module 120. For example, a light absorber 128 can dissipate absorbed light as heat to manage temperature with an optical module 120.

The optical module 120 can include one or more sensors to detect objects in front of the vehicle 116. For example, a sensor within an optical module 120 can detect an oncoming vehicle 116 in front of the vehicle 116. In another example, a sensor can detect a pedestrian walking in front of the vehicle 116. In yet another example, a sensor can detect a street sign on the side of the road, in front of the vehicle 116. The one or more sensors can be configured to detect object up to a certain distance away from the vehicle. For example, a sensor can detect objects up to 10 meters away. In another example, a sensor can detect objects up to 15 meters away.

In response to detecting objects in front of the vehicle 116, the light absorber 128 can employ one or more light traps to create an excluded zone 302 with the high-definition area 222. The excluded zone 302 can be an area where the one or more light traps have removed all light at specific angles from the origin 224. For example, a sensor of an optical module 102 can detect an oncoming vehicle 116 at an angle of 35 degrees from the origin 224 of a vehicle 116. Therefore, the optical module 120 can trigger a light absorber 128 to employ one or more light traps to absorb all light that would normally travel at an angle of 35 degrees and prevent a light beam 220 from reaching the oncoming vehicle 116.

The optical module 120 can use sensors to calculate a shape for the excluded zone 302. The shape can be at least one of a square, a rectangle, a circle, or an ellipse, among others. For example, if a pedestrian is further away from a vehicle 116, a sensor may calculate a square for an excluded zone 302, whereas a sensor may calculate a rectangle for the excluded zone 302 when the pedestrian is closer to the vehicle 116. The sensor can constantly update the excluded zone 302 if the object is in motion. For example, a sensor of the optical module 120 calculate a square for an excluded zone 302 for an oncoming vehicle 116, as the oncoming vehicle approaches an electric vehicle 116, the excluded zone 302 can get bigger.

The system 100 can include the projector 108 within the data processing system 102. The projector 108 can have the same structure and hardware components as the processor 130. The projector 108 can receive instructions or signals from the pixel controller 106 to project a graphic 304 within the light beam 220. For example, a pixel controller 106 can send a signal to a projector 108 to generate a graphic 304 based on the array of micromirrors 122. The graphic 304 can be a visual element to represent information or to improve communication. The graphic 304 can include images 112, signals, or markers, among others to represent an action of the vehicle 116. For example, a graphic 304 can be an arrow. In another example, a graphic 304 can be a number. In yet another example, a graphic 304 can be a phrase saying, “Turning Right.” The graphic 304 can be a hazard indicator (as shown in FIG. 3) for a pothole, object, or dangerous occurrence on the road. For example, the light beam 220 can project a graphic 304 (e.g., hazard indicator) in response to the detection of a pothole.

The projector 108 can send a signal to the pixel controller 106 to generate the graphic 304. For example, a projector 108 can send a signal to the pixel controller 106 including a graphic 304. The pixel controller 106 can trigger one or more micromirrors 122 to change the state 114. An optical module 120 can project the graphic 304 from the light source 126. The projector 108 can communicate with other systems of the electric vehicle 116 to trigger the graphic 304 in response to actions taken by a driver of the electric vehicle 116. For example, a driver of an electric vehicle 116 can use a right turn signal to turn right. A projector 108 may receive the signal and send a right arrow as a graphic 304 to a pixel controller 106 to project the right arrow to pedestrians and other vehicles 116.

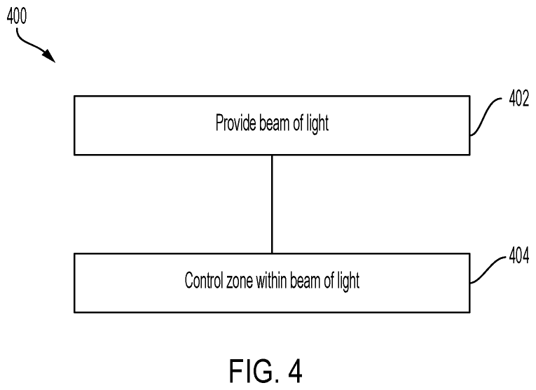

FIG. 4 depicts a flow diagram illustrating an example method of executing the DMD high resolution lamp. The method 400 can be performed by system 100, a battery back 206, one or more processors (e.g., processor 130, pixel controller 106, state selector 104, projector 108) or an electric vehicle 116. At ACT 402, the method 400 can include providing a beam of light. At ACT 404, the method 400 can include controlling a zone within the beam of light.

At ACT 402, the method 400 can include providing a beam of light where the beam of light includes an origin 224. The method can include disposing an optical module (e.g., optical module 120) within a headlamp (e.g., headlamp 116). The method can include powering on the headlamp to provide the beam of light. The method can include generating the beam of light using a light source (e.g., light source 126) of the optical module. The method can include adjusting a lens (e.g., lens 124) within the optical module to arrange the beam of light. The method can include using a light absorber (e.g., 128) to sharpen the beam of light.

At ACT 404, the method 400 can include controlling a zone within the beam of light to provide a graphic within the beam of light. The zone can include a contrast ratio of at least 400:1 within at least a 20 degree by 10-degree field of view from the origin. The zone can have the contrast ratio within 400:1 and 600:1. The zone can have one 1000 lumens. The graphic can be an image (e.g., images 112) indicative of an action a vehicle. The method can include using an array of micromirrors (e.g., micromirrors 122). The array of micromirrors includes 1.2 million to 1.5 million micromirrors. The method can include controlling at least one micromirrors of the array of micromirrors in unison to define a pixel. The pixel can include micromirrors at a resolution of 9:5. The method can include controlling the array of micromirrors by changing one or more micromirrors of the array of micromirrors from a first state (e.g., states 114) to a second state (e.g., states 114).

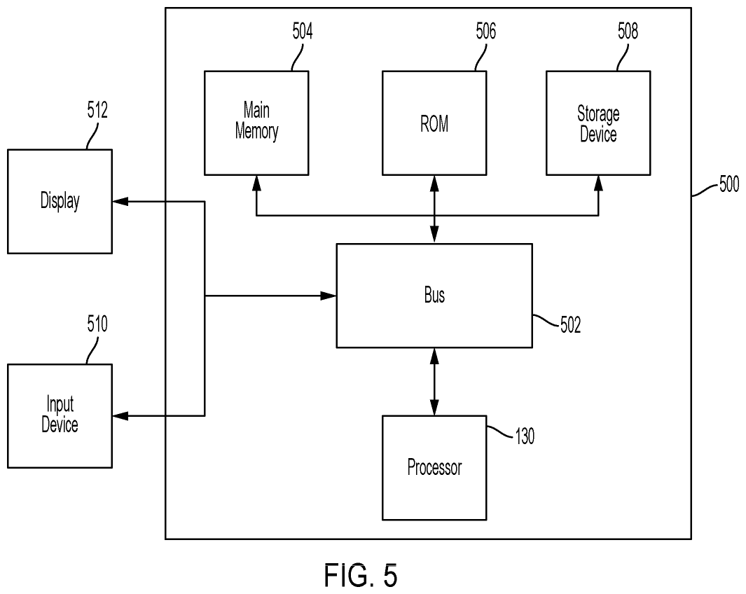

FIG. 5 depicts an example of a computer system 500 within the electric vehicle 116. The computer system 500 can have the same functionality of the data processing system 102 described herein. The computer system 500 can include a bus 502, main memory 504, ROM 506, a storage device 508 and a processor 130. The computing system 500 can communicate with a display 512 and an input device 510. The main memory 504, ROM 506, and the storage device 508 can be the memory 110 or be located within the memory 110. The bus 502 can be any communication bus described herein to effect communication and processing. The display 512 can be any user interface including the one or more UI elements to a user of the electric vehicle 116 in accordance with a configuration the display 512. The UI elements may correspond to visual components of the user interface, such as a command button, a text box, a check box, a radio button, a menu item, and a slider, among others.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. For example, negative busbar and a positive busbar can be reversed, as well as negative current collector and the positive current collector. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

1. A system, comprising:
an optical module configured to dispose in a headlamp, the optical module comprising an array of micromirrors; and
one or more processors coupled with memory, configured to:
provide a beam of light comprising an origin;
control, using the array of micromirrors, a zone within the beam of light configured to project a graphic within the beam of light;
detect an object within the zone; and
control a subset of the array of micromirrors to create an excluded zone that includes the object by preventing light from reflecting from the subset of the array of micromirrors into the excluded zone, the subset of the array of micromirrors configured to prevent at least a portion of the beam of light from reaching the object within the zone.

2. The system of claim 1, wherein the zone has at least a 400:1 contrast ratio within at least a 20 degrees by 10 degrees field of view from the origin.

3. The system of claim 1, comprising:
the one or more processors configured to control between 900,000 to 1 million pixels and wherein each pixel comprises at least one micromirror of the array of micromirrors.

4. The system of claim 1, comprising:
the one or more processors configured to control the array of micromirrors by changing one or more micromirrors of the array of micromirrors from a first state to a second state.

5. The system of claim 1, wherein the array of micromirrors comprises between 1.2 million to 1.5 million micromirrors.

6. The system of claim 1, wherein the zone has a contrast ratio between 400:1 and 600:1.

7. The system of claim 1, wherein the pixel comprises micromirrors at a resolution of 9:5.

8. The system of claim 1, wherein the one or more processors are configured to illuminate the beam of light from the headlamp including the optical module, wherein the shape of the headlamp is a stadium shape.

9. The system of claim 1, wherein the one or more processors are configured to adjust an angle of at least one micromirror of the array of micromirrors in unison to define a pixel.

10. The system of claim 1, wherein the optical module is disposed within the headlamp.

11. A method, comprising:
providing, by one or more processors coupled with memory, a beam of light comprising an origin;
controlling, by the one or more processors using an array of micromirrors disposed within an optical module, a zone within the beam of light to project a graphic within the beam of light;
detecting, by the one or more processors an object within the zone;
controlling, by the one or more processors, a subset of the array of micromirrors to create an excluded zone that includes the object by preventing light from reflecting from the subset of the array of micromirrors into the excluded zone; and
preventing, by the one or more processors using the subset of the array of micromirrors, at least a portion of the beam of light from reaching the object within the zone.

12. The method of claim 11, wherein the zone has at least a 400:1 contrast ratio within at least a 20 degrees by 10 degrees field of view from the origin.

13. The method of claim 11, comprising:
controlling, by the one or more processors, between 900,000 to 1 million pixels and wherein each pixel comprises at least one micromirror of the array of micromirrors.

14. The method of claim 11, wherein the one or more processors are configured to control the array of micromirrors by changing one or more micromirrors of the array of micromirrors from a first state to a second state.

15. The method of claim 11, wherein the array of micromirrors comprises between 1.2 million to 1.5 million micromirrors.

16. The method of claim 11, wherein the zone has a contrast ratio between 400:1 and 600:1.

17. The method of claim 11, wherein the one or more processors are configured to control at least one light source to illuminate the beam of light from a headlamp including the optical module, the headlamp having a shape, wherein the shape of the headlamp is a stadium shape.

18. The method of claim 11, wherein the one or more processors are configured adjust an angle of at least one micromirror of the array of micromirrors in unison to define a pixel.

19. An electric vehicle, comprising:
an optical module configured to dispose in a headlamp of the electric vehicle, the optical module comprising an array of micromirrors; and
one or more processors coupled with memory, configured to:
provide a beam of light comprising an origin;
control, using the array of micromirrors, a zone within the beam of light configured to project a graphic within the beam of light;
detect an object within the zone; and
control a subset of the array of micromirrors to create an excluded zone that includes the object by preventing light from reflecting from the subset of the array of micromirrors into the excluded zone, the subset of the array of micromirrors configured to prevent at least a portion of the beam of light from reaching the object within the zone.

20. The electric vehicle of claim 19, wherein the zone has at least a 400:1 contrast ratio within at least a 20 degrees by 10 degrees field of view from the origin.
